(19) United States
(12) Patent Application Publication
(10) Pub. No.: US 2023/0051281 A1
(43) Pub. Date: Feb. 16, 2023

(54) COLOR CORRECTION OF AN IMAGE

(71) Applicant: Hewlett-Packard Development Company, L.P., Spring, TX (US)

(72) Inventors: Di-Yuan Tzeng, Boise, ID (US); Jerry Wagner, Boise, ID (US)

(21) Appl. No.: 17/794,035

(22) PCT Filed: Apr. 21, 2020
(86) PCT No.: PCT/US2020/029132

§ 371 Date: Jul. 20, 2022

(51) Int. Cl. H04N 1/60

(52) U.S. Cl. CPC H04N 1/6027; H04N 1/6002; H04N 2201/0081

(57) ABSTRACT

A method for color correction of an image includes generating a plurality of gain modules for an image scanning device, where each gain module of the plurality of gain modules includes a ratio of a maximum light intensity and a scanned white intensity. The method may further include generating a plurality of color correction modules, wherein each color correction module is associated with a respective gain module. Responsive to receipt of instructions to perform a scan of a document, the method may include identifying a color correction module of the plurality of color correction modules to apply and applying the identified color correction module to an image of the scanned document.

### BACKGROUND

Scanners and copiers are office machines that provide office functions both in the workplace and at home. Various scanners and copiers include image processing that may automatically filter unwanted information from a scanned document.

### BRIEF DESCRIPTION OF THE DRAWINGS

FIG. 1 illustrates an example method for color correction of an image, consistent with the present disclosure.

FIG. 2 is a chart illustrating example variances between a plurality of different gain modules, consistent with the present disclosure.

FIG. 3 illustrates an example computing apparatus, for color correction of an image, consistent with the present disclosure.

FIG. 4 illustrates an example image scanning device for color correction of images, consistent with the present disclosure.

FIG. 5 illustrates a flow diagram for color correction of images, consistent with the present disclosure.

FIG. 6 further illustrates a flow diagram for color correction of images, consistent with the present disclosure.

### DETAILED DESCRIPTION

In the following detailed description, reference is made to the accompanying drawings which form a part hereof, and in which is shown by way of illustration specific examples in which the disclosure may be practiced. It is to be understood that other examples may be utilized, and structural or logical changes may be made without departing from the scope of the present disclosure. The following detailed description, therefore, is not to be taken in a limiting sense, and the scope of the present disclosure is defined by the appended claims. It is to be understood that features of the various examples described herein may be combined, in part or whole, with each other, unless specifically noted otherwise.

Two-sided documents, i.e., documents having text and/or pictorial content on both sides of the paper, present challenges for producing quality copies of the original documents. When two-sided documents are scanned in a copy machine or a scanner, visual noise may appear in the copies that was not present on the scanned surfaces of the original documents. The visual noise may be the result of digitally captured text and/or pictorial content printed on the opposite side of a scanned surface. The appearance of visual noise caused by unwanted blurry text and/or blurry pictorial content is referred to herein as the “bleed-through” effect.

The bleed-through effect is more prevalent for copies of documents having a white or very light color background. In addition, the thickness of the scanned documents may increase the intensity of the visual noise, since thinner paper is more transparent than thicker paper. In general, documents typically contain black characters that are printed on thin white paper. Thus, the quality of document copies can be significantly increased if the visual bleed-through noise can be effectively removed from the copies.

The paper on which a scanned original is printed has a reflectance of 90%. Because the paper is not perfectly white (i.e., not 100% reflectance), a background signal is present in the scanned image. To improve image quality, in accordance with the present disclosure, the background signal is removed from the scanned image by saturating the scanned white to be 100% of intensity in digital representation. The result of this saturation is that the paper white background is the maximum signal intensity for monitor display and zero toner or ink for copy output.

Copiers, network scanners, e.g., digital senders, and multi-functional printers may have difficulty reducing or eliminating background and bleed-through noise, and often reduce this noise by sacrificing the color fidelity of pastel colors (e.g., light and low chromatic colors). Color correction of an image, consistent with the present disclosure, resolves the engineering challenges of maintaining the color fidelity of pastel colors and reducing the image quality impact of background and bleed-through for copies and digitally transmitted documents.

Consistent with various examples, a method for color correction of an image includes generating a plurality of gain modules for an image scanning device, where each gain module of the plurality of gain modules includes a ratio of a maximum light intensity and a scanned white intensity. The method may further include generating a plurality of color correction modules, wherein each color correction module is associated with a respective gain module. Responsive to receipt of instructions to perform a scan of a document, the method may include identifying a color correction module of the plurality of color correction modules to apply and applying the identified color correction module to an image of the scanned document.

As a further example, color correction of an image may be performed by an apparatus including a non-transitory machine-readable medium. The non-transitory machine-readable medium may store instructions that when executed by a processor, cause the processor to store a plurality of gain modules for an image scanning device, wherein each gain module of the plurality of gain modules includes a ratio of a maximum light intensity and a scanned white intensity. Furthermore, the non-transitory machine-readable medium may store instructions that when executed by a processor, cause the processor to store a plurality of color correction modules, wherein each color correction module is associated with a respective gain module. Responsive to receipt of a scan job, the processor may determine a duplex setting of the scan job and a thickness of a document to be scanned. Moreover, the non-transitory machine-readable medium may store instructions that when executed by the processor, cause the processor to identify a color correction module of the plurality of color correction modules to apply to the scan job, based in part on the duplex setting and the thickness of the document, and apply the identified color correction module to an image of the scanned document.

In yet a further example, color correction of an image, consistent with the present disclosure, may be performed by an image scanning device. In such examples, the image scanning device may include embedded image processing circuitry including instructions to store a plurality of gain modules for the image scanning device, wherein each gain module of the plurality of gain modules includes a ratio of a maximum light intensity and a scanned white intensity, and store a plurality of color correction modules, wherein each color correction module is associated with a respective gain module. The image scanning device may also include a non-transitory machine-readable medium storing instructions that when executed cause the image scanning device to, responsive to receipt of a scan job, determine a duplex setting of the scan job and a thickness of a document to be scanned. The medium may further include instructions to identify a color correction module of the plurality of color correction modules to apply to the scan job, based in part on the duplex setting and the thickness of the document, and apply the identified color correction module to an image of the scanned document.

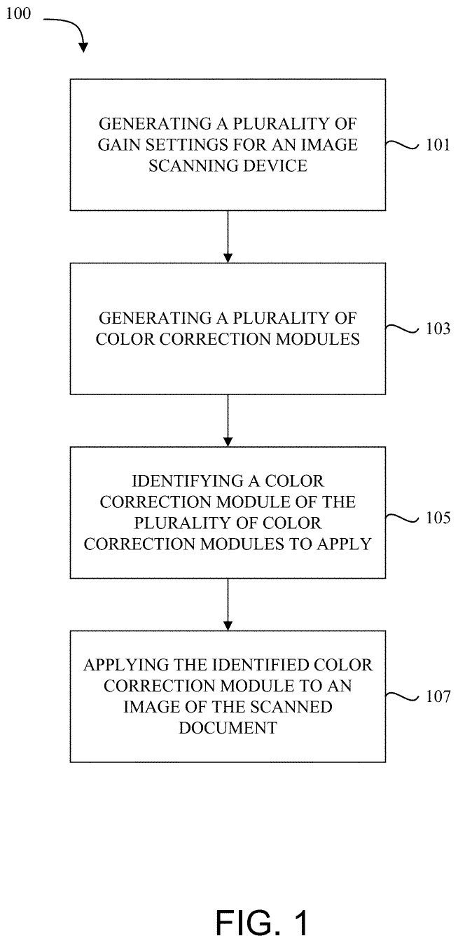

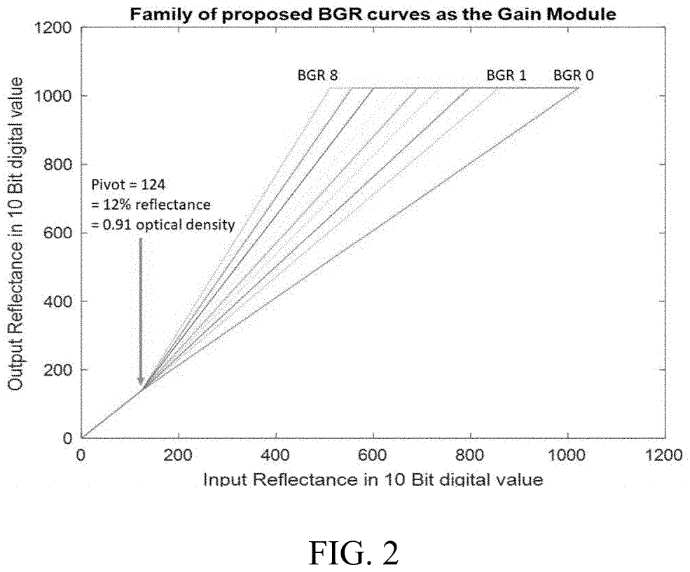

Turning now to the figures, FIG. 1 illustrates an example method 100 for color correction of an image, consistent with the present disclosure. As illustrated in FIG. 1, the method 100 includes generating a plurality of gain modules for an image scanning device, at 101. As used herein, a gain module refers to or includes a ratio of a maximum light intensity and a scanned white intensity. For example, a gain module includes a numerical value that indicates an amount in which the intensity of various portions of the scanned image are brightened or darkened. The gain module can be implemented as a set of one-dimensional look-up tables with a design based on a predefined paper media white's reflectance. An example set of gain modules is shown in FIG. 2.

In various examples, a plurality of gain modules may be generated, each gain module associated with a different level at which the scanned image is lightened. As a non-limiting example, a total of nine gain modules may be generated and labeled from 0 to 8. Each gain module is associated with a different respective gain strength. An example of such gain modules and associated gain strength is included in Table 1 below:

TABLE 1
Example gain modules and their corresponding gain strength.

| Gain | | | | | | | | | |
|---|---|---|---|---|---|---|---|---|---|
| Module | 0 | 1 | 2 | 3 | 4 | 5 | 6 | 7 | 8 |
| Gain | 1.00 | 1.19 | 1.28 | 1.39 | 1.48 | 1.58 | 1.7 | 1.84 | 2.0 |
| strength | | | | | | | | | |

As mentioned above, the number of gain modules and the associated gain strength are provided as non-limiting examples. More or fewer gain modules may be generated, with different gain strengths.

At 103, the method 100 includes generating a plurality of color correction modules. A color correction module is a 3-dimensional to 3-dimensional look up table transforming scanned RGB (red, green, blue) intensity into another digital representation suitable to match human perception (digital scan output) or suitable for printing (copy output). In such examples, each color correction module is associated with a respective gain module. Bleed-through may result from the hardware setup of the scanner's illumination and the translucency of the paper used, and a number of color correction modules (or color transform tables) may be used in order to implement the plurality of gain modules. An example of such color correction modules, the associated gain module, and the associated gain strength, is provided in Table 2, below:

TABLE 2
Example gain modules, corresponding gain strength, and color
correction module.

| Gain | | | | | | | | | |
|---|---|---|---|---|---|---|---|---|---|
| module | 0 | 1 | 2 | 3 | 4 | 5 | 6 | 7 | 8 |
| Gain | 1.00 | 1.19 | 1.28 | 1.39 | 1.48 | 1.58 | 1.7 | 1.84 | 2.0 |
| strength | | | | | | | | | |
| Color | 1 | 1 | 2 | 3 | 3 | 3 | 3 | 3 | 3 |
| correction | | | | | | | | | |
| module | | | | | | | | | |

A number of different color correction modules may be generated, and each color correction module may be associated with at least one gain module. As a non-limiting example, a first color correction module may be designated to convert the color signals sampled from gain modules 0 and 1, a second color correction module may be designated to convert the color signals sampled from gain module 2, and a third color correction module may be designated to convert the color signals sampled from gain modules 3, 4, 5, 6, 7, and 8. Gain modules 3, 4, 5, 6, 7, and 8 may be grouped together in a same color correction module, because the color fidelity of these gain modules are often not a concern since such settings are used when encountering originals with very dark backgrounds or significant bleed-through. The end user is often less concerned with color accuracy and more concerned with reducing the toner or ink usage on a darker background. Therefore, these gain modules may be deemed as the user's conscious image quality adjustments, with color distortion accepted as a trade-off in removing background color.

The design of the gain module 0 has a similar justification. In the example provided above, the gain module 0 may be used for very thin originals and/or lightly printed document content. The color fidelity of documents with gain module 0 selected is often not a concern, but the readability is often the objective.

In various examples, at 105, the method 100 includes identifying a color correction module of the plurality of color correction modules to apply. In some examples, a user may select a gain module, such as via a graphical user interface. Accordingly, in some examples, the method 100 includes receiving as input, a selection of a gain module. Responsive to selection of a particular gain module by the user, the associated color correction module may be selected. Therefore, the method 100 may include identifying the color correction module based on the selection of the gain module.

In some examples, a particular color correction module may be designated as a default color correction module. For instance, the default color correction module may be used to correct the color of the image if a gain module is not selected by the user or a gain module was set as a default. Accordingly, the method 100 may include automatically applying a default color correction module responsive to identifying that a selection of a gain module has not been received.

Additionally and/or alternatively, processing software may automatically remove noise, e.g., background or bleed through, without erroneously deleting important content. In various examples, a color correction module is automatically identified responsive to receipt of instructions to perform a scan of a document. A color correction module of the plurality of color correction modules may be selected to apply to the scan, based on received scan settings. As used herein, scan settings may refer to or include selection of a duplex setting, e.g., whether the document is duplex or simplex, selection of a particular paper weight used in the original, and/or other settings associated with scanning the original document or object.

At 107, the method 100 includes applying the identified color correction module to an image of the scanned document.

FIG. 2 is a chart illustrating example variances between a plurality of different gain modules, consistent with the present disclosure. In this example, the lower portion of the curves, until the illustrated pivot point, are kept constant to maintain black level. After the pivot point, the output reflectance for each gain module (also referred to as BGR curve), relative to the input reflectance increases. Each of the curves illustrated in FIG. 2 represents a different respective gain module. For instance, BGR 0 illustrated in FIG. 2, corresponds with gain module 0, BGR 1 illustrated in FIG. 2, corresponds with gain module 1, and so forth.

In constructing the gain modules illustrated in FIG. 2, the scanned white intensity of paper was pre-mapped to represent a physical unit of reflectance of the scanned white paper which was measured to be 89% of reflectivity. The gain module (BGR) then further converts 89% of intensity in digital representation to 100% of the input value or stronger depending on the settings other than BGR0 which is an identity transformation, and therefore increases the overall scanned image brightness to remove the bleed through and any paper background remaining due to scanner illumination non-uniformity. Each gain module consists of a gain value (determined by paper background level and a bleed-through target), combined with a curve shape (illustrated in FIG. 2) to maintain a correct dark level for consistent text quality. The plurality of gain modules may be stored in instructions of an image scanning device, and therefore “pre-loaded” on the device.

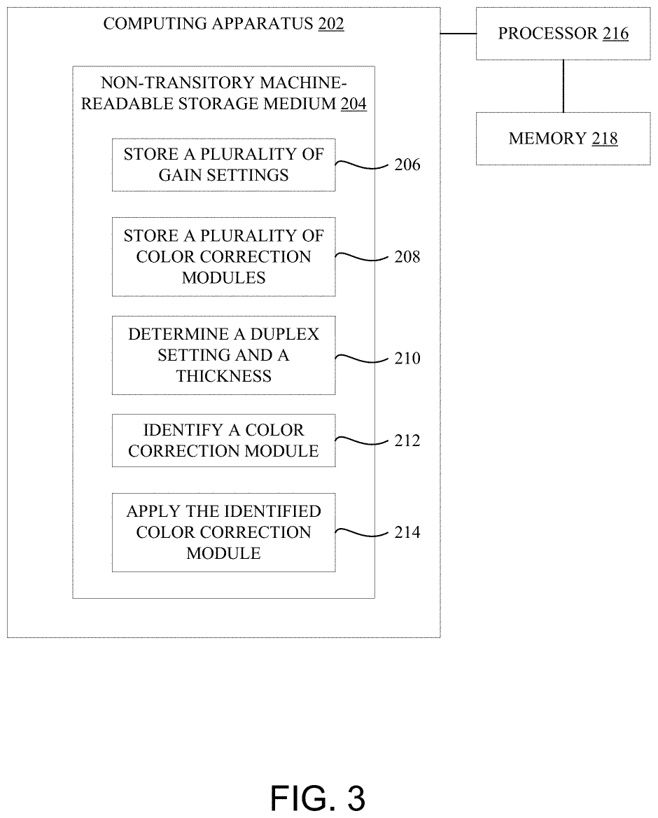

FIG. 3 illustrates an example computing apparatus 202, for color correction of an image, consistent with the present disclosure. The computing apparatus 202 may include a processor 216, a non-transitory machine-readable storage medium 204, and a memory 218.

The processor 216 may be a central processing unit (CPU), a semiconductor-based microprocessor, and/or other hardware devices suitable to control operations of the computing apparatus 202. Non-transitory machine-readable storage medium 204 may be an electronic, magnetic, optical, or other physical storage device that contains or stores executable instructions. Thus, non-transitory machine-readable storage medium 204 may be, for example, Random Access Memory (RAM), an Electrically Erasable Programmable Read-Only Memory (EEPROM), a storage device, an optical disc, etc. As used herein, the term ‘non-transitory’ does not encompass transitory propagating signals. As described in detail below, the non-transitory machine-readable storage medium 204 may be encoded with a series of executable instructions 206-214. In some examples, non-transitory machine-readable storage medium 204 may implement a memory 218. Memory 218 may be any non-volatile memory, such as EEPROM, flash memory, etc.

As illustrated, the non-transitory machine-readable storage medium 204 may store instructions 206 that, when executed, cause the computing apparatus 202 to store a plurality of gain modules for an image scanning device, wherein each gain module of the plurality of gain modules includes a ratio of a maximum light intensity and a scanned white intensity.

Additionally, the non-transitory machine-readable storage medium 204 may store instructions 208 that, when executed, cause the computing apparatus 202 to store a plurality of color correction modules, wherein each color correction module is associated with a respective gain module.

In various examples, the non-transitory machine-readable storage medium 204 may store instructions 210 that, when executed, cause the computing apparatus 202 to, responsive to receipt of a scan job, determine a duplex setting of the scan job and a thickness of a document to be scanned. As described herein, the user selections (such as background removal level, simplex/duplex) may be made on a job basis. Additionally, the automatic features described herein may be applied on a page-by-page basis within a job. As used herein, a duplex setting refers to or includes a selection of either duplex scanning in which both sides of the document are to be scanned, or simplex scanning in which one side of the document is to be scanned. In such examples, the computing apparatus 202 may receive, such as from a user via a user interface, a selection of duplex or simplex for the scan job. If the scan is set to duplex, then both sides of the document may be scanned, and a higher color correction module may be selected. If the scan is set to simplex, then a single side of the document may be scanned, and a lower color correction module may be selected.

Yet further, the thickness of the original document may be used to select a color correction module. For example, often 20-pound (lb.)/75 gram per square meter (gsm) paper is often used in printers/copiers/multifunction printers. If the scanned original is on paper heavier than 90 gsm, then less bleed-through may occur and therefore a lower color correction module may be selected. If, however, the scanned original is on paper less than 90 gsm, then more bleed-through may occur and a higher color correction module may be selected.

Additional scan settings may be used for selecting a color correction module. For instance, if duplex is selected for the scan job, then it is assumed that both sides of the scanned document have content. If simplex is selected for the scan job, then both sides of the document may still be scanned, and content on the back side of the document may be detected. If content is detected on both sides, then a higher color correction module may be selected to prevent bleed-through. If content is not detected on both sides, then a lower color correction module may be selected.

As used herein, a scan job refers to or includes instructions to scan images, objects, and/or documents. Scanned images can be sent from the device as scans, or they can be printed as copies. The scanned images may be sent over a network by email, sent over a network to a folder, sent by facsimile, and/or printed as a copy of the original.

As discussed herein, the non-transitory machine-readable storage medium 204 may store instructions 212 that, when executed, cause the computing apparatus 202 to identify a color correction module of the plurality of color correction modules to apply to the scan job, based in part on the duplex setting and the thickness of the document. For instance, if the thickness of the document is greater than 90 gsm, the lowest color correction module may be selected. If the thickness of the document is less than 90 gsm, the computing apparatus 202 may determine whether the document is duplex or simplex. If the document is simplex, then the lowest color correction module may be selected. If the document is duplex, then the highest (or a higher) color correction module may be selected.

In various examples, the non-transitory machine-readable storage medium 204 may store instructions 214 that, when executed, cause the computing apparatus 202 to apply the identified color correction module to an image of the scanned document.

The machine-readable storage medium 204 is not limited to the instructions illustrated in FIG. 3, and additional and/or different instructions may be stored and executed by processor 216 and/or other components of computing apparatus 202. For instance, the machine-readable storage medium 204 may store instructions that, when executed, cause the computing apparatus 202 to automatically select the gain module and color correction module pair to apply to the scan job based on the duplex setting and the thickness of the document, as discussed with regards to FIG. 1. This information can be used for automatic selection of the optimal gain module prior to embedded image processing. If a user decides to turn off the automatic color correction, then a default gain module may be used.

Additionally and/or alternatively, the machine-readable storage medium 204 may store instructions that, when executed, cause the computing apparatus 202 to receive a selection of a gain module, and apply the identified color correction module to the image of the scanned document based on the selection of the gain module.

As an illustration, the machine-readable storage medium 204 may store instructions that, when executed, cause the computing apparatus 202 to select a first color correction module for scan jobs including a gain module less than a default level, e.g., such as a gain module less than 2 from Table 2. The computing apparatus 202 may select a second color correction module for scan jobs including a gain module at a default level, e.g., such as a gain module of 2 from Table 2. Moreover, the machine-readable storage medium 204 may store instructions to select a third color correction module for scan jobs including a gain module greater than the default level, e.g., such as a gain module of 3 or greater from Table 2.

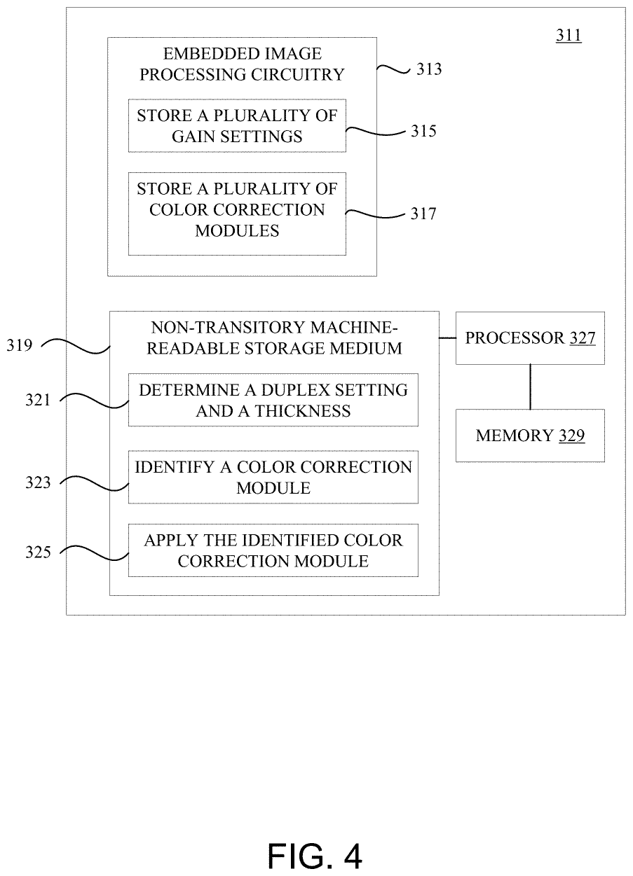

As discussed more thoroughly with regards to FIG. 4, the instructions to construct the various gain modules and color correction modules may be implemented in embedded image processing circuitry and retrieved by instructions or firmware in the computing apparatus. After the gain modules and color correction modules are constructed and implemented in the embedded image processing circuitry, these modules may be used as a basis for automatic gain module selection when a copy or digital send job is initiated.

FIG. 4 illustrates an example image scanning device 311 for color correction of images, consistent with the present disclosure. As used herein, an image scanning device refers to or includes copiers, digital senders, and multi-function printers. As discussed with regards to FIG. 1 and FIG. 3, images of documents and/or objects scanned by the image scanning device 311 may undergo embedded electronic signal processing to accomplish hi-fidelity color or enhanced image quality reproduction. The embedded image processing may decide on the gain of the signal intensity for the scanned copy original paper's background (nominal plain and uncoated paper background is 90% reflectance) such that the paper white background will be the maximum signal intensity for monitor display and zero toner or ink for copy output. As such, the scanned white's signal intensity is measured, and a ratio is identified between the maximum intensity and the scanned white's intensity to apply in the embedded image processing. The resultant gain module is discussed with regards to FIG. 1 and FIG. 3, above.

As illustrated in FIG. 4, the image scanning device 311 includes embedded image processing circuitry 313. The embedded image processing circuitry 313 may include instructions 315 to store the plurality of gain modules for the image scanning device. As discussed herein, each gain module of the plurality of gain modules may include a ratio of a maximum light intensity and a scanned white intensity. Moreover, the embedded image processing circuitry 313 may include instructions 317 to store a plurality of color correction modules, wherein each color correction module is associated with a respective gain module. Table 2 above provides an example of the color correction modules and associated gain modules.

The image scanning device 311 may further include a processor 327, a non-transitory machine-readable storage medium 319, and a memory 329.

The processor 327 may be a central processing unit (CPU), a semiconductor-based microprocessor, and/or other hardware devices suitable to control operations of the image scanning device 311. Non-transitory machine-readable storage medium 319 may be an electronic, magnetic, optical, or other physical storage device that contains or stores executable instructions. Thus, non-transitory machine-readable storage medium 319 may be, for example, Random Access Memory (RAM), an Electrically Erasable Programmable Read-Only Memory (EEPROM), a storage device, an optical disc, etc. As used herein, the term ‘non-transitory’ does not encompass transitory propagating signals. As described in detail below, the non-transitory machine-readable storage medium 319 may be encoded with a series of executable instructions 321, 323, and 325. In some examples, non-transitory machine-readable storage medium 319 may implement a memory 329. Memory 329 may be any non-volatile memory, such as EEPROM, flash memory, etc.

The instructions 321, when executed, cause the image scanning device 311 to determine a duplex setting of the scan job and a thickness of a document to be scanned, responsive to receipt of a scan job.

The instructions 323, when executed, cause the image scanning device 311 to identify a color correction module of the plurality of color correction modules to apply to the scan job, based in part on the duplex setting and the thickness of the document. For instance, the image scanning device 311 may include a plurality of sensors (not illustrated in FIG. 4), and the image scanning device may determine the thickness of the document based on measurements obtained by the plurality of sensors.

In various examples, the non-transitory machine-readable storage medium 319 may include instructions that when executed, cause the image scanning device to select a first color correction module responsive to an indication that the scan job is a simplex scan job. As a further example, the medium 319 may include instructions that when executed cause the image scanning device to select a third color correction module responsive to an indication that the scan job is a duplex scan job.

In some examples, the medium 319 may include instructions that when executed cause the image scanning device to select a default color correction module responsive to a determination that a selection of a gain module has not been selected. The instructions 325, when executed, cause the image scanning device 311 to apply the identified color correction module to an image of the scanned document.

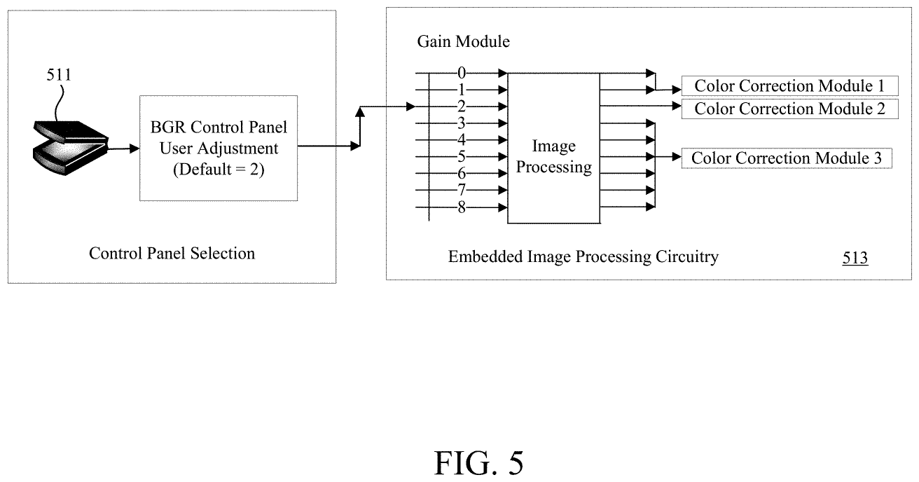

FIG. 5 illustrates a flow diagram for color correction of images, consistent with the present disclosure. As discussed with regards to FIG. 2, a plurality of gain modules may be pre-loaded on the image scanning device 511. A graphical user interface may provide a selection of the gain modules for a user to select, e.g., a BGR Control Panel User Adjustment. Absent user selection, a default level such as 2 may be selected. Examples are not so limited, and different gain modules may be selected as a default. After the gain module is selected, embedded image processing circuitry 513 may select the corresponding color correction module. For example, if gain module 0 or 1 were received as the control panel selection, the embedded image processing circuitry 513 may select color correction module 1 for correcting the output of the color image. Similarly, if the second gain module were received as the control panel selection, the embedded image processing circuitry 513 may select color correction module 2 for correcting the output of the color image. Additionally, if gain modules 3-8 were received as the color panel selection, the embedded image processing circuitry 513 may select color correction module 3 for correcting the output of the color image. As discussed herein, more, fewer, and/or different gain modules and corresponding color correction modules than illustrated in FIG. 5 may be used.

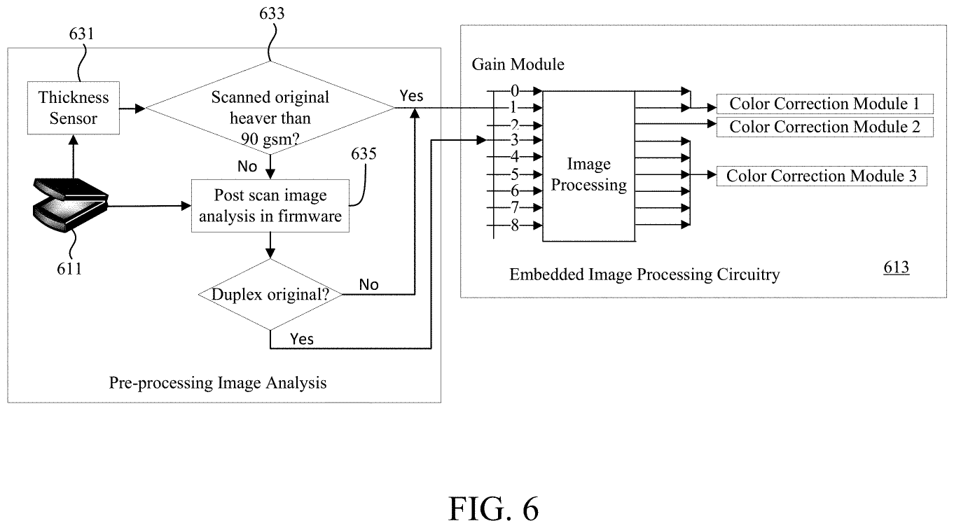

FIG. 6 further illustrates a flow diagram for color correction of images, consistent with the present disclosure. As discussed with regards to FIG. 5, a plurality of pre-processing image analysis steps may be performed prior to selection of the corresponding color correction module by the embedded image processing circuitry 613. For instance, a graphical user interface on the image scanning device 611 may provide a selection of the gain modules for a user to select, e.g., a BGR Control Panel User Adjustment. At 631, the method proceeds and the image scanning device 611 detects the thickness of the paper, such as via a thickness sensor. As discussed herein, if at 633, the thickness is determined to be heaver than 90 gsm, then gain module 1 and the corresponding color correction module 1 are selected by embedded image processing circuitry 613. Also, if at 633, the thickness is determined to not be heavier than 90 gsm, then the process continues to 635. At 635, the method includes conducting a post scan image analysis in firmware. For example, the document is examined for duplex versus simplex content. If at 635 it is determined that the original document is duplex, then gain module 3 and the corresponding color correction module 3 are selected by the embedded image processing circuitry 613. If at 635 it is determined that the original document is simplex, then gain module 1 and the corresponding color correction module 1 are selected by the embedded image processing circuitry 613, as discussed further herein.

Although specific examples have been illustrated and described herein, a variety of alternate and/or equivalent implementations may be substituted for the specific examples shown and described without departing from the scope of the present disclosure. This application is intended to cover any adaptations or variations of the specific examples discussed herein. Therefore, it is intended that this disclosure be limited only by the claims and the equivalents thereof.

1. A method, comprising:
generating a plurality of gain modules for an image scanning device, wherein each gain module of the plurality of gain modules includes a ratio of a maximum light intensity and a scanned white intensity;
generating a plurality of color correction modules, wherein each color correction module is associated with a respective gain module;
responsive to receipt of instructions to perform a scan of a document, identifying a color correction module of the plurality of color correction modules to apply; and
applying the identified color correction module to an image of the scanned document.

2. The method of claim 1, including receiving as input, a selection of a gain module.

3. The method of claim 2, further including identifying the color correction module based on the selection of the gain module.

4. The method of claim 1, including automatically applying a default color correction module responsive to identifying that a selection of a gain module has not been received.

5. The method of claim 1, including identifying the color correction module of the plurality of color correction modules to apply to the scan, based on received scan settings.

6. A non-transitory machine-readable medium storing instructions that when executed by a processor, cause the processor to:
store a plurality of gain modules for an image scanning device, wherein each gain module of the plurality of gain modules includes a ratio of a maximum light intensity and a scanned white intensity;
store a plurality of color correction modules, wherein each color correction module is associated with a respective gain module;
responsive to receipt of a scan job, determine a duplex setting of the scan job and a thickness of a document to be scanned;
identify a color correction module of the plurality of color correction modules to apply to the scan job, based in part on the duplex setting and the thickness of the document; and
apply the identified color correction module to an image of the scanned document.

7. The non-transitory machine-readable medium of claim 6, including instructions to automatically select the color correction module to apply to the scan job based on the duplex setting and the thickness of the document.

8. The non-transitory machine-readable medium of claim 6, including instructions to receive a selection of a gain module, and apply the identified color correction module to the image of the scanned document based on the selection of the gain module.

9. The non-transitory machine-readable medium of claim 6, including instructions to select a first color correction module for scan jobs including a gain module of less than a default level, and select a second color correction module for scan jobs including a default gain module.

10. The non-transitory machine-readable medium of claim 9, including instructions to select a third color correction module for scan jobs including a gain module greater than the default level.

11. An image scanning device, comprising:
embedded image processing circuitry including instructions to:
store a plurality of gain modules for the image scanning device, wherein each gain module of the plurality of gain modules includes a ratio of a maximum light intensity and a scanned white intensity; and
store a plurality of color correction modules, wherein each color correction module is associated with a respective gain module;
a non-transitory machine-readable medium storing instructions that when executed cause the image scanning device to:
responsive to receipt of a scan job, determine a duplex setting of the scan job and a thickness of a document to be scanned;
identify a color correction module of the plurality of color correction modules to apply to the scan job, based in part on the duplex setting and the thickness of the document; and
apply the identified color correction module to an image of the scanned document.

12. The image scanning device of claim 11, including a plurality of sensors, the image scanning device to determine the thickness of the document based on measurements obtained by the plurality of sensors.

13. The image scanning device of claim 11, further including instructions that when executed cause the image scanning device to select a first color correction module responsive to an indication that the scan job is a simplex scan job.

14. The image scanning device of claim 13, further including instructions that when executed cause the image scanning device to select a third color correction module responsive to an indication that the scan job is a duplex scan job.

15. The image scanning device of claim 11, further including instructions that when executed cause the image scanning device to select a default color correction module responsive to a determination that a selection of a gain module has not been selected.
